(19) United States
(12) Patent Application Publication
(10) Pub. No.: US 2025/0105335 A1
(43) Pub. Date: Mar. 27, 2025

(54) Manufacturing Method of Electrode Assembly

(71) Applicant: LG ENERGY SOLUTION, Ltd, Seoul (KR)

(72) Inventors: Tai Joon Seo, Daejeon (KR); Lae Seo Park, Daejeon (KR)

(73) Assignee: LG ENERGY SOLUTION, Ltd., Seoul (KR)

(21) Appl. No.: 18/576,964

(22) PCT Filed: Sep. 16, 2022
(86) PCT No.: PCT/KR2022/013888

§ 371 Date: Jan. 5, 2024

(51) Int. Cl. H01M 10/04

(52) U.S. Cl. CPC H01M 10/0459; H01M 10/0404

(57) ABSTRACT

An electrode assembly is manufactured in a process in which a positive electrode and a negative electrode are alternately stacked and a separator is positioned between the positive electrode and the negative electrode. The positive electrode is disposed above a first separator in a first step. A second separator is disposed above the positive electrode to cover the positive electrode in a second step. A negative electrode is disposed above the second separator in a third step. A third separator is disposed above the negative electrode to cover the negative electrode in a fourth step. In the first step and the third step, a laser beam is irradiated to indicate positions at which the positive electrode and the negative electrode are disposed.

### CROSS-REFERENCE TO RELATED APPLICATIONS

The present application is a national phase entry under 35 U.S.C. § 371 of International Application No. PCT/KR2022/013888 filed on Sep. 16, 2022, and now published as International Publication No. WO 2023/043265, which claims priority from Korean Patent Application No. 10-2021-0124048 filed on Sep. 16, 2021, all of which are hereby incorporated herein by reference in their entireties.

### FIELD

The present invention relates to a manufacturing method of an electrode assembly, and more specifically, to a manufacturing method of an electrode assembly capable of accurately and easily aligning an electrode.

### BACKGROUND

Due to rapid increase in use of fossil fuels, demand for use of alternative energy or clean energy is increasing. Thus, the field of power generation and electricity storage, which use electrochemical reaction, is most actively studied.

As a representative example of electrochemical devices using electrochemical energy, secondary batteries are currently used and use thereof is gradually expanding.

Recently, as technology for portable devices, such as portable computers, portable phones, cameras, and the like, continues to develop and demand therefor continues to increase, demand for secondary batteries as energy sources is rapidly increasing. Among these secondary batteries, research on lithium secondary batteries having high energy density, high operating voltage, long cycle lifespan, and a low self-discharge rate has been underway, and such lithium secondary batteries are commercially available and widely used.

In addition, as interest in environmental problems is increasing, research into electric vehicles, hybrid electric vehicles, and the like that can replace vehicles using fossil fuels, such as gasoline vehicles, diesel vehicles, and the like, which are one of the main causes of air pollution, is underway. As a power source of electric vehicles, hybrid electric vehicles, and the like, a nickel-metal hydride secondary battery is mainly used. However, research into lithium secondary batteries having high energy density and high discharge voltage is actively carried out and some lithium secondary batteries are commercially available.

In the lithium secondary battery, a positive electrode or a negative electrode active material, a binder, and a conductive material are coated on a current collector in a form of a slurry and then the coated current collector is dried to form an electrode mixture layer so that a positive electrode and a negative electrode are manufactured, and a separator is interposed between the positive electrode and the negative electrode. The lithium secondary battery is manufactured by embedding an electrode assembly obtained by laminating the positive electrode and the negative electrode with the separator interposed therebetween into a battery case together with an electrolyte solution.

In addition, the electrode assembly may be manufactured in a form of stacking or folding components of the electrode assembly or may be manufactured in a form of manufacturing a unit cell as an electrode assembly including the electrode and the separator and stacking or folding the manufactured unit cell.

That is, in general, the electrode assembly composed of a stacked structure of a positive electrode/separator/negative electrode may be manufactured, and for example, the electrode assembly is configured so that the positive electrode and the negative electrode are alternately and sequentially stacked between separator sheets arranged in a zigzag pattern. In the manufacturing method of the electrode assembly, the electrode assembly is formed by repeating a method in which the positive electrode is disposed, a separator sheet is disposed above or on the positive electrode, the negative electrode is disposed above or on the separator sheet, and then the separator sheet is folded so as to cover the negative electrode disposed above the separator sheet.

In this case, since a following electrode is disposed in a state in which the separator sheet is covered above an electrode (the negative electrode or the positive electrode) when the electrode is disposed, it is difficult to determine whether the following electrode is aligned at an accurate position. Because of this, if the alignment of the electrode is not made at the accurate position, a defect may occur at a completed electrode assembly, and in addition, if it is checked whether the alignment of the electrodes is made in the accurate position every time the electrodes is stacked, there is a problem in which a process is delayed and becomes complicated.

### SUMMARY OF THE DISCLOSURE

An object to be solved by the present invention is to provide a manufacturing method of an electrode assembly capable of aligning a position of each electrode at an accurate position by a simple method in a process of manufacturing the electrode assembly by alternately stacking an electrode and a separator.

However, the problem to be solved by embodiments of the present invention is not limited to the above-described problem and may be variously expanded in the range of the technical ideas included in the present invention.

A manufacturing method of an electrode assembly according to an embodiment of the present invention in which a positive electrode and a negative electrode are alternately stacked and a separator is positioned between the positive electrode and the negative electrode includes: a first step of disposing the positive electrode above a first separator; a second step of disposing a second separator above the positive electrode to cover the positive electrode; a third step of disposing a negative electrode above the second separator; and a fourth step of disposing a third separator above the negative electrode to cover the negative electrode. In the first step and the third step, a laser beam is irradiated to indicate positions at which the positive electrode and the negative electrode are disposed.

A size of the negative electrode may be larger than a size of the positive electrode, and a thickness of the laser beam may correspond to a size of a gap between a position where one side of the negative electrode is disposed and a position where one side of the positive electrode corresponding to the one side of the negative electrode is disposed.

A first side of the laser beam in a longitudinal direction may coincide with the one side of the positive electrode, and a second side of the laser beam parallel to the first side may coincide with the one side of the negative electrode.

The first separator, the second separator, and the third separator may be integrally formed as one separator sheet.

The second step may include covering the positive electrode with one side of the separator sheet, and the fourth step may include covering the negative electrode with the other side of the separator sheet.

The first step to the fourth step may be repeatedly performed, and an irradiation position of the laser beam may be fixed during the repeatedly performed process.

The laser beam may be irradiated from a laser oscillator, and a height of the laser oscillator from an irradiation object may be adjusted by a height adjusting device.

As the height of the laser oscillator from the irradiation object increases, a thickness of the laser beam may become thin.

A manufacturing apparatus of an electrode assembly in which a positive electrode and a negative electrode are alternately stacked and a separator is positioned between the positive electrode and the negative electrode according to an embodiment of the present invention may include a laser oscillator that irradiates a laser beam toward the positive electrode and the negative electrode. A thickness of the laser beam irradiated from the laser oscillator may correspond to a size of a gap between a position where one side of the negative electrode is disposed and a position where one side of the positive electrode corresponding to the one side of the negative electrode is disposed.

The manufacturing apparatus of the electrode assembly may further include a height adjusting device connected to the laser oscillator and adjusting a height between the laser oscillator and an irradiation object. As a height of the laser oscillator from the irradiation object increases, a thickness of the laser beam becomes thin.

According to embodiments of the present invention, it is possible to align a positive electrode and a negative electrode continuously stacked at an accurate position without adding a complicated process when an electrode assembly is manufactured so that a defect is prevented from occurring without delaying a process.

Effects of the present invention are not limited to the foregoing effects, and other non-mentioned effects will be clearly understood by those skilled in the art from the description below.

### BRIEF DESCRIPTION OF THE DRAWINGS

FIGS. 1 to 4 are schematic elevation views showing a manufacturing method of an electrode assembly according to an embodiment.

FIG. 5 is a series of plan views showing steps of the manufacturing method of the electrode assembly according to an embodiment.

FIG. 6A and FIG. 6B are elevation views illustrating a subsequent process in the manufacturing method of the electrode assembly according to an embodiment.

FIG. 7A and FIG. 7B is an elevation view illustrating a change in a thickness of a laser beam according to a height of a laser oscillator in the manufacturing method of the electrode assembly according to an embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Parts that are irrelevant to the description are omitted in the drawings for clear description, and like reference numerals designate like elements throughout the specification.

Further, the size and thickness of the elements shown in the drawings are arbitrarily illustrated for better understanding and ease of description, and the present invention is not necessarily limited thereto. In the drawings, the thickness of layers, films, panels, regions, etc., are exaggerated for clarity. In the drawings, for convenience of description, the thickness of layers, films, panels, areas, etc., are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion and does not necessarily mean positioned on the upper side of the object portion based on a gravitational direction.

In addition, unless explicitly described to the contrary, the word “comprise”, and variations such as “comprises” or “comprising”, will be understood to imply the inclusion of stated elements but not the exclusion of any other elements.

Further, throughout the specification, the phrase “on a plane” means viewing a target portion from the top, and the phrase “on a cross-section” means viewing a cross-section formed by vertically cutting a target portion from the side.

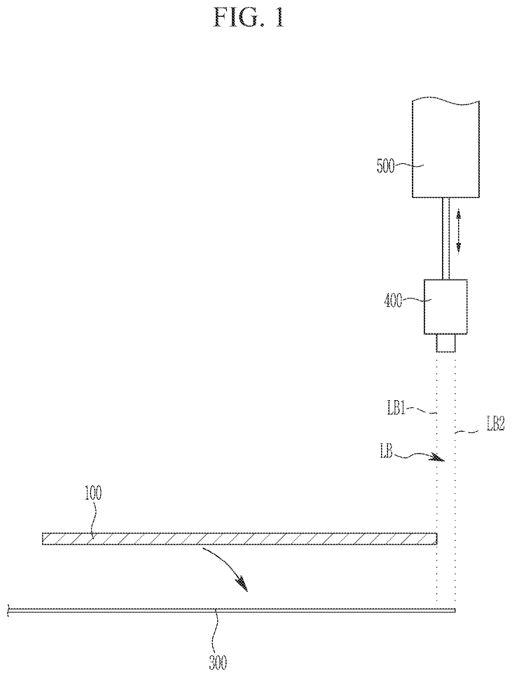

Hereinafter, a manufacturing method of an electrode assembly according to an embodiment will be described with reference to FIGS. 1 to 6.

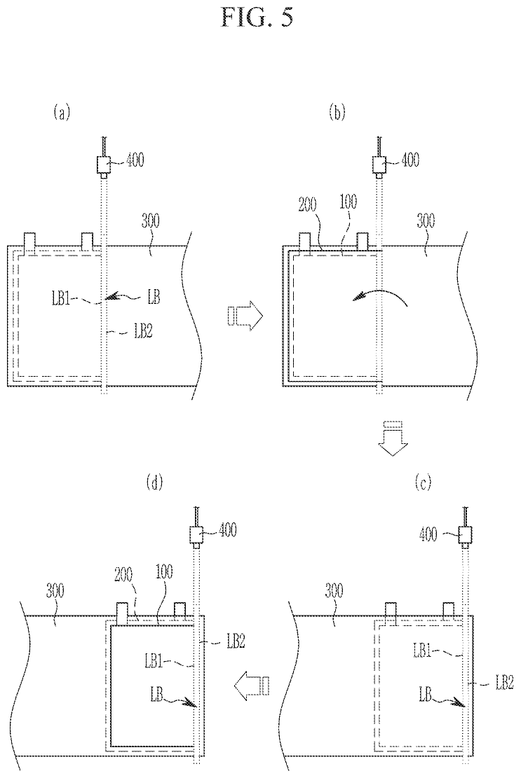

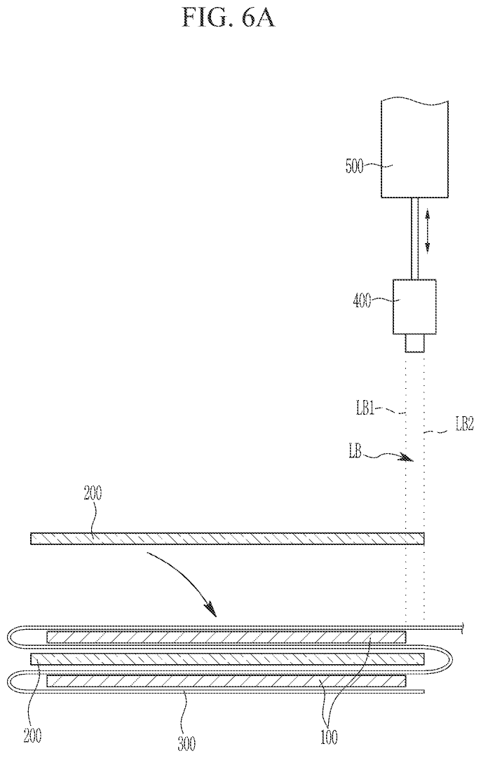

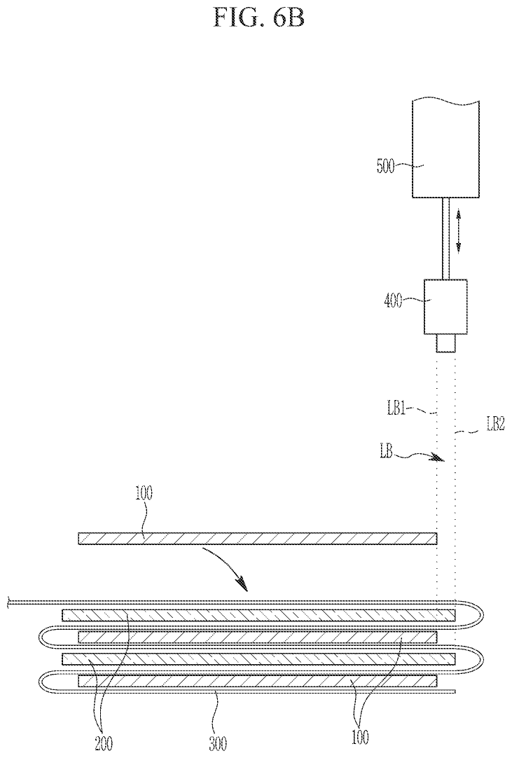

FIGS. 1 to 4 are elevation views showing a manufacturing method of an electrode assembly according to an embodiment, FIG. 5 is a view for explaining the manufacturing method of the electrode assembly according to an embodiment on a plane, and FIG. 6A and FIG. 6B are views illustrating a subsequent process in the manufacturing method of the electrode assembly according to an embodiment.

Referring to FIGS. 1 to 5, the manufacturing method of the electrode assembly according to the embodiment is a method of manufacturing the electrode assembly in which a positive electrode 100 and a negative electrode 200 are alternately stacked and a separator (or a separation membrane) 300 is positioned between the positive electrode 100 and the negative electrode 200.

First, as shown in FIG. 1, the positive electrode 100 is disposed above or on the separator 300 (a first step).

The separator 300 may be a separator sheet in which separators disposed between the electrodes are integrally formed but is not limited thereto. A first separator 300 disposed below the positive electrode 100 may be referred to as a first separator. If the separator 300 has a porous structure that is interposed between the positive electrode 100 and the negative electrode 200, has an insulating property, and allows ion movement, a material of the separator is not particularly limited and the separator may be appropriately used.

The positive electrode 100 disposed above the separator 300 may be manufactured by applying (or coating) a mixture of a positive electrode active material, a conductive material, and a binder above or on a current collector and by drying and pressing the applied mixture above the current collector.

In the first step, a position of the positive electrode 100 is marked by radiating a laser beam LB from a laser oscillator 400 so that the positive electrode 100 may be disposed at a desired position. That is, the laser beam LB may be irradiated in a straight line having a thickness on one surface of an irradiation object. In this case, the laser beam LB in the straight line may extend in a longitudinal direction of the laser beam LB and may have two sides LB1 and LB2 parallel to each other. A first side LB1 positioned inside the separator 300 may be irradiated to coincide with one side of the positive electrode 100 so that a placement position of the positive electrode is indicated.

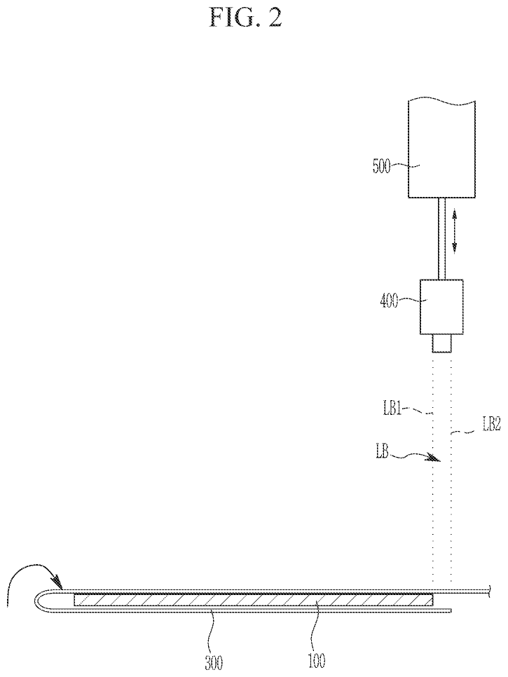

Next, as shown in FIG. 2, the separator 300 is disposed on the positive electrode 100 to cover the positive electrode 100 (a second step).

In this case, the separator 300 may be disposed by covering an upper portion of the positive electrode 100 with one side of the separator 300 that is positioned below the positive electrode 100 and is in a form of a sheet. That is, the upper portion of the positive electrode 100 is covered by folding the separator 300 in a direction of an arrow in FIG. 2. Thus, a second separator 300 disposed at the upper portion of the positive electrode 100 may be referred to as a second separator.

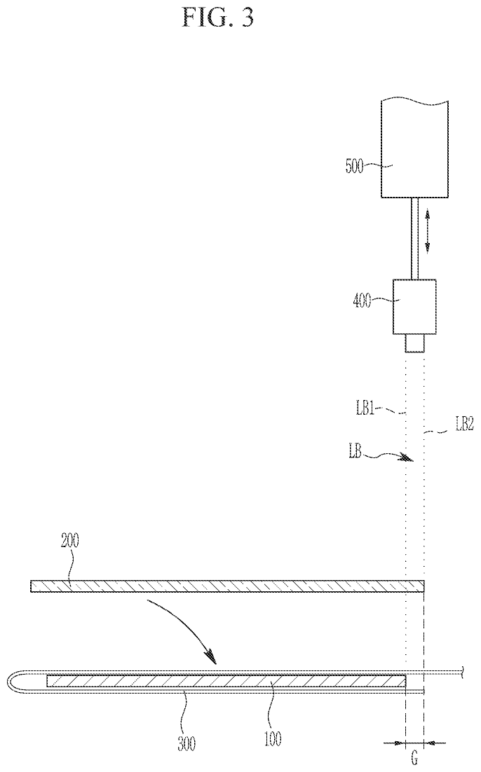

Next, as shown in FIG. 3, the negative electrode 200 is disposed above or on the separator 300 (a third step).

The negative electrode 200 may be manufactured by applying a mixture of a negative electrode active material, a conductive material, and a binder above or on a current collector and by drying and pressing the applied mixture above the current collector.

In the third step, the negative electrode 200 needs to be aligned at an accurate position corresponding to the position of the positive electrode 100 already disposed therebelow. However, since the separator 300 covers the positive electrode 100, it is difficult to determine an accurate position of the positive electrode 100 positioned below the separator 300. Therefore, there is a problem in which it is not easy to detect an accurate position of the negative electrode 200 corresponding to the accurate position of the positive electrode 100 and to align the negative electrode at the accurate position of the negative electrode. However, since the accurate position of the negative electrode 200 is indicated by irradiating the laser beam LB in the present embodiment, the accurate position of the negative electrode 200 may be checked by the laser beam LB even if the position of the electrode positioned below is covered by the separator 300. Thus, it is possible to align the negative electrode 200 at the accurate position.

In this case, the negative electrode 200 may have a larger area than the positive electrode 100, and a thickness of the laser beam LB corresponds to a size difference between the negative electrode 200 and the positive electrode 100. Specifically, the thickness of the laser beam LB corresponds to a size of a gap between a position where one side of the negative electrode 200 is disposed and a position where one side of the positive electrode 100 corresponding to the one side of the negative electrode 200 is disposed. That is, as shown in FIG. 3, at step (a) of FIG. 5, and step (b) of FIG. 5, by irradiating a single laser beam LB having the same thickness as a gap G between an end portion of the negative electrode 200 and an end portion of the positive electrode 100, it is possible to simultaneously indicate the position of the positive electrode 100 and the position of the negative electrode 200. In a state where the laser beam LB is irradiated, a second side LB2, which is an outer side of the laser beam LB, indicates a position of one side of the negative electrode 200. Thus, as shown in FIG. 3 and step (b) of FIG. 5, by disposing the one side of the negative electrode 200 to coincide with the second side LB2, the negative electrode 200 may be aligned at the accurate position.

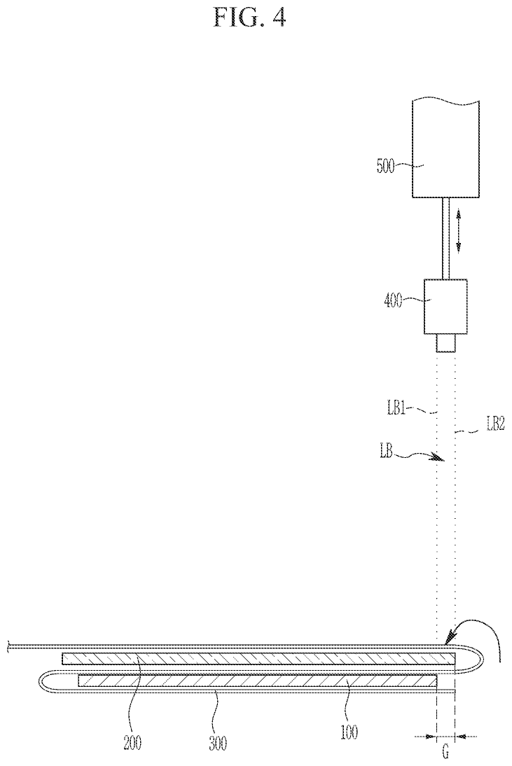

Next, as shown in FIG. 4, the separator 300 is disposed above or on the negative electrode 200 to cover the negative electrode 200 (a fourth step).

In this case, the separator 300 may be disposed by covering an upper portion of the negative electrode 200 with one side of the separator 300 that is positioned below the negative electrode 200 and is in a form of a sheet. That is, the negative electrode 200 may be covered by folding the separator 300 in an opposite direction to a direction in which the separator 300 is folded in the second step. For example, the separator 300 may be folded in a direction of an arrow in FIG. 4 and in a direction of an arrow at step (b) in FIG. 5. Thus, a third separator 300 disposed at the upper portion of the negative electrode 200 may be referred to as a third separator.

By repeating the above first to fourth steps, the electrode assembly may be completed by stacking the positive electrode 100 and the negative electrode 200 as many times as desired. In this regard, FIGS. 6A and 6B show a state in which stacking is further performed after the first to fourth steps. That is, FIG. 6A shows a step of stacking an additional positive electrode 100 and the separator 300 and then stacking the negative electrode 200 again after the fourth step, and FIG. 6B shows a step of further stacking the positive electrode 100 after covering the separator 300 that follows the step of FIG. 6B.

In this process, by fixing the laser beam LB at the same position and continuously irradiating the laser beam LB, a disposition position of the positive electrode 100 and a disposition position of the negative electrode 200 may be indicated in the same way. Thus, it is possible to dispose the positive electrode 100 and the negative electrode 200 at the same position without occurrence of error even if the process continues continuously. In particular, by a simple configuration of irradiating one laser beam LB having a width corresponding to the gap between an end portion of the negative electrode 200 and an end portion of the positive electrode 100 without adding a particularly complicated process, there is an advantage in which both the position of the positive electrode 100 and the position of the negative electrode 200 may be indicated. Therefore, according to an embodiment, it is possible to prevent a defect due to an alignment error by aligning the positive electrode 100 and the negative electrode 200 at an accurate position through a simple process.

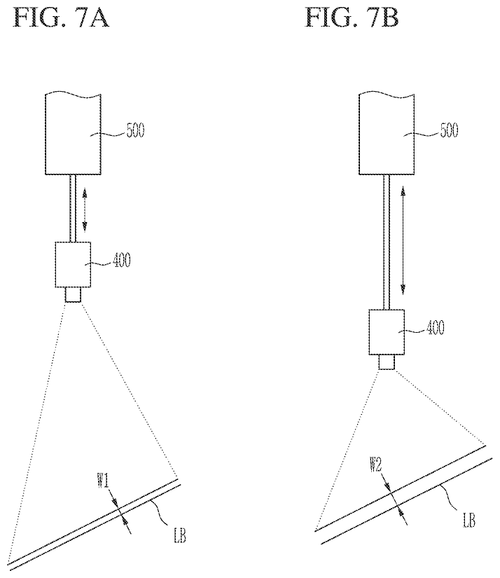

Next, with reference to FIGS. 7A and 7B, a thickness adjustment of the laser beam LB according to an embodiment will be described.

FIGS. 7A and 7B are elevation views illustrating a change in a thickness of a laser beam according to a height of the laser oscillator in the manufacturing method of the electrode assembly according to an embodiment.

As shown in FIGS. 7A and 7B, the laser oscillator 400 used in the manufacturing method of the electrode assembly according to the embodiment may be connected to a height adjusting device 500 so that a height from the irradiation object is variably adjusted. In this case, as a height from the irradiation object increases, a thickness of the laser beam LB decreases. That is, when the laser oscillator 400 is moved upward by the height adjusting device 500 so as to increase the height from the irradiation object as shown in FIG. 7A, a width W1 of the laser beam LB becomes thin. On the other hand, when the laser oscillator 400 is moved downward by the height adjusting device 500 so as to decrease the height from the irradiation object as shown in FIG. 7B, a width W2 of the laser beam LB becomes thick. The height adjusting device 500 capable of such control is not particularly limited and may be appropriately selected and applied.

According to this configuration, since a thickness of the laser beam LB for indicating the positions of the positive electrode 100 and the negative electrode 200 is easily changed according to a configuration, specification, or the like of the electrode, various specifications of electrode assemblies may be manufactured without special modification of a manufacturing apparatus.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: positive electrode
200: negative electrode
300: separator
400: laser oscillator
500: height adjusting device
LB: laser beam

1. A manufacturing method of an electrode assembly in which a positive electrode and a negative electrode are alternately stacked and a separator is positioned between the positive electrode and the negative electrode, comprising:
a first step of disposing the positive electrode above a first separator;
a second step of disposing a second separator above the positive electrode to cover the positive electrode;
a third step of disposing a negative electrode above the second separator; and
a fourth step of disposing a third separator above the negative electrode to cover the negative electrode,
wherein during the first step and the third step, a laser beam is irradiated to indicate positions at which the positive electrode and the negative electrode are disposed.

2. The manufacturing method of the electrode assembly of claim 1, wherein a size of the negative electrode is larger than a size of the positive electrode, and wherein a thickness of the laser beam corresponds to a size of a gap between a position where one side of the negative electrode is disposed and a position where one side of the positive electrode corresponding to the one side of the negative electrode is disposed.

3. The manufacturing method of the electrode assembly of claim 2, wherein a first side of the laser beam in a longitudinal direction coincides with the one side of the positive electrode, and wherein a second side of the laser beam parallel to the first side coincides with the one side of the negative electrode.

4. The manufacturing method of the electrode assembly of claim 1, wherein the first separator, the second separator, and the third separator are integrally formed as one separator sheet.

5. The manufacturing method of the electrode assembly of claim 4, wherein the second step includes covering the positive electrode with one side of the separator sheet, and wherein the fourth step includes covering the negative electrode with the other side of the separator sheet.

6. The manufacturing method of the electrode assembly of claim 1, wherein the first step to the fourth step are repeatedly performed, and wherein an irradiation position of the laser beam is fixed during the repeatedly performed process.

7. The manufacturing method of the electrode assembly of claim 1, wherein the laser beam is irradiated from a laser oscillator, and further comprising a step of adjusting a height of the laser oscillator from an irradiation object by a height adjusting device.

8. The manufacturing method of the electrode assembly of claim 7, wherein as the height of the laser oscillator from the irradiation object increases, a thickness of the laser beam becomes thinner.

9. A manufacturing apparatus of an electrode assembly in which a positive electrode and a negative electrode are alternately stacked and a separator is positioned between the positive electrode and the negative electrode, comprising a laser oscillator that irradiates a laser beam toward the positive electrode and the negative electrode,
wherein a thickness of the laser beam irradiated from the laser oscillator corresponds to a size of a gap between a position where one side of the negative electrode is disposed and a position where one side of the positive electrode corresponding to the one side of the negative electrode is disposed.

10. The manufacturing apparatus of the electrode assembly of claim 9, further comprising a height adjusting device connected to the laser oscillator and configured for adjusting a height between the laser oscillator and an irradiation object,
wherein as a height of the laser oscillator from the irradiation object increases, a thickness of the laser beam becomes thinner.

11. The manufacturing method of the electrode assembly of claim 1,
wherein a size of the negative electrode is larger than a size of the positive electrode,
wherein a thickness of the laser beam corresponds to a size of a gap between a position where one side of the negative electrode is disposed and a position where one side of the positive electrode corresponding to the one side of the negative electrode is disposed,
wherein the first separator, the second separator, and the third separator are integrally formed as one separator sheet, and
wherein the first step to the fourth step are repeatedly performed, and wherein an irradiation position of the laser beam is fixed during the repeatedly performed process.

12. The manufacturing method of the electrode assembly of claim 11, wherein a first side of the laser beam in a longitudinal direction coincides with the one side of the positive electrode, and wherein a second side of the laser beam parallel to the first side coincides with the one side of the negative electrode.

13. The manufacturing method of the electrode assembly of claim 12, wherein the laser beam is irradiated from a laser oscillator and further comprising a step of adjusting a height of the laser oscillator from an irradiation object by a height adjusting device.

14. The manufacturing method of the electrode assembly of claim 13, wherein as the height of the laser oscillator from the irradiation object increases, a thickness of the laser beam becomes thinner.

15. The manufacturing method of the electrode assembly of claim 11, wherein the laser beam is irradiated from a laser oscillator and further comprising a step of adjusting a height of the laser oscillator from an irradiation object by a height adjusting device.

16. The manufacturing method of the electrode assembly of claim 15, wherein as the height of the laser oscillator from the irradiation object increases, a thickness of the laser beam becomes thinner.
